(19) United States
(12) Patent Application Publication
(10) Pub. No.: US 2012/0264514 A1
(43) Pub. Date: Oct. 18, 2012

(54) ELECTRONIC DEVICE AND THREE-DIMENSIONAL EFFECT SIMULATION METHOD

(75) Inventors: HOU-HSIEN LEE, Tu-Cheng (TW); CHANG-JUNG LEE, Tu-Cheng (TW); CHIH-PING LO, Tu-Chen (TW)

(73) Assignee: HON HAI PRECISION INDUSTRY CO., LTD., Tu-Cheng (TW)

(21) Appl. No.: 13/404,010

(22) Filed: Feb. 24, 2012

(30) Foreign Application Priority Data
Apr. 18, 2011 (TW) 100113315

(51) Int. Cl. A63F 13/00

(52) U.S. Cl. 463/32

(57) ABSTRACT

An electronic device includes a three-dimensional (3D) effect simulation unit. The unit sets an initial position of a virtual camera that tracks 3D game scenes of a 3D game in 3D space and a viewpoint position of a user, and determines an initial sightline direction of the user according to the initial position and the viewpoint position. An object represented by two-dimensional (2D) graphics is placed in the 3D scenes, where a plane of the 2D graphics is vertical to the initial sightline direction of the user. The simulation unit determines a current sightline direction of the user according to a current position of the virtual camera and the viewpoint position, and adjusts view of the plane of the 2D graphics representing the object to be vertical to the current sightline direction of the game player.

### BACKGROUND

1. Technical Field

The embodiments of the present disclosure relate to simulation technology, and particularly to an electronic device and a method for simulating three-dimensional effect using two-dimensional graphics.

2. Description of Related Art

Models of three-dimensional (3D) objects (such as game scenes and characters) of games run in electronic devices (such as mobile phones) are often created using 3D drawing software. The 3D models are then divided into multiple polygons for producing vivid effects. One problem is that, if a number of the polygons divided from the 3D models is too great, running the games in the electronic devices may require a high level hardware configuration. For example, if processing capability of the electronic devices is not fast enough, frames of the games may be not played smoothly.

### BRIEF DESCRIPTION OF THE DRAWINGS

FIG. 1 is one embodiment of a block diagram of an electronic device including a three-dimensional (3D) effect simulation unit.

FIG. 2 is one embodiment of function modules of the 3D effect simulation unit in FIG. 1.

FIG. 3 is a flowchart of one embodiment of a 3D effect simulation method.

FIG. 4A, FIG. 5A, and FIG. 6A illustrate 3D effects simulated by 2D graphics.

FIG. 4B, FIG. 5B, and FIG. 6B illustrate top views of FIG. 4A, FIG. 5A, and FIG. 6A.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

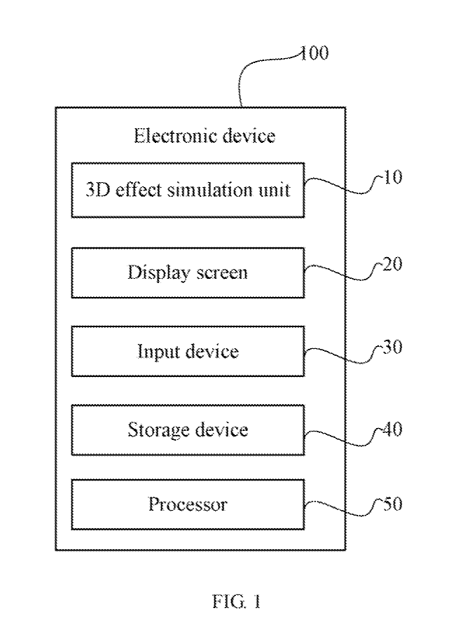

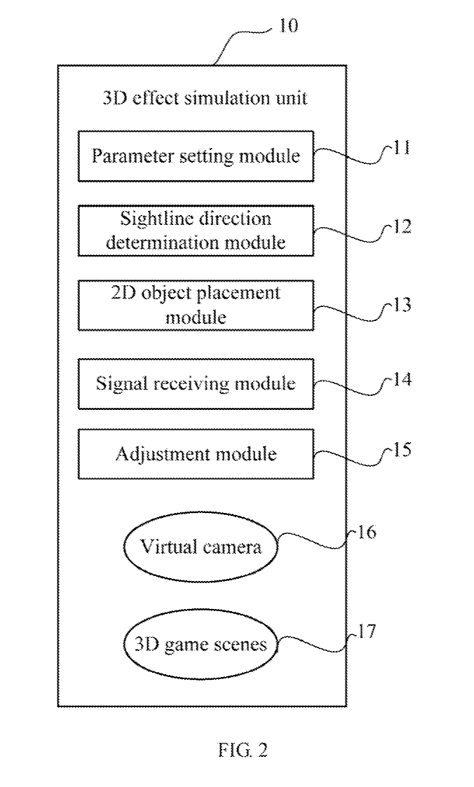

FIG. 1 is one embodiment of a block diagram of an electronic device 100. In one embodiment, the electronic device 100 includes a three-dimensional (3D ) effect simulation unit 10, a display screen 20, an input device 30, a storage device 40, and a processor 50. The electronic device 100 may be a computer, a mobile phone, or a personal digital assistant, for example.

The 3D effect simulation unit 10 depicts minor objects, such as minor characters (e.g., people) or components of three-dimensional (3D ) scenes 17 displayed on the display screen 20, which appear much less frequently in 3D games by two-dimensional (2D ) graphics. In one embodiment, “objects” are defined as all things, such as characters, buildings, landscapes, weapons, appear in the 3D scenes. The objects that appear much less frequently in the 3D games are minor objects, while the objects that appear much more frequently in the 3D games are main objects.

When a 3D game is run by the electronic device 100, the 3D effect simulation unit 10 determines sightline directions of a user (such as a game player) according to positions of a virtual camera 16 that tracks the 3D scenes 17 in a 3D space and the user's viewpoint position. The 3D effect simulation unit 10 further adjusts planes of the 2D graphics to keep vertical with the sightline directions of the user, so that the users cannot recognize the objects are represented by 2D graphics. When playing the 3D game, eyes of the user act as the virtual camera 16 for tracking the 3D game scenes 17 in the 3D space.

The display screen 20 displays the 3D scenes 17 of the 3D games. The 3D scenes 17 include main objects (such as main characters and main landscapes of 3D scenes) represented by 3D models and minor objects represented by 2D graphics.

The input device 30 receives adjustment signals for adjusting sightline directions of the user. The input device 30 may be a keyboard or a mouse, for example.

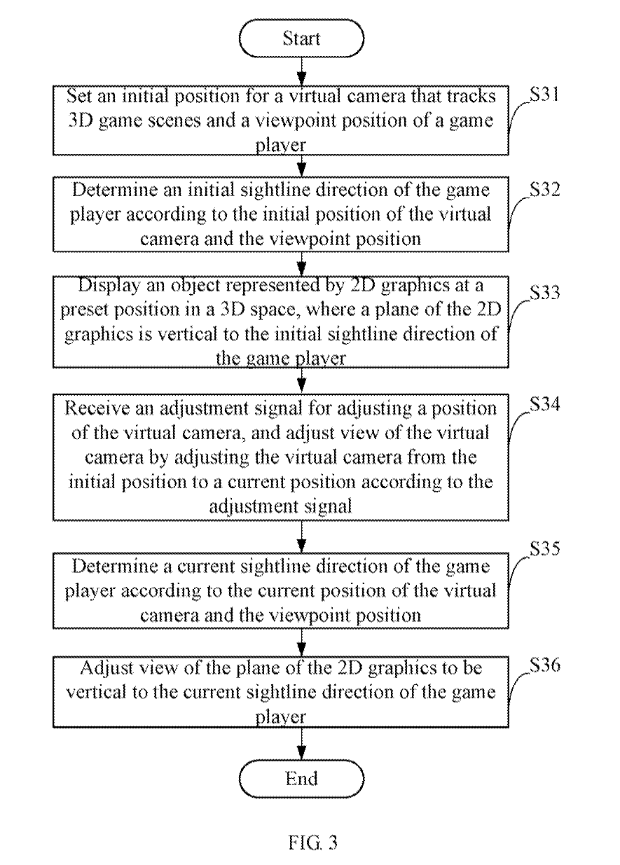

As shown in FIG. 2, the 3D effect simulation unit 10 includes a parameter setting module 11, a sightline direction determination module 12, a 2D object placement module 13, a signal receiving module 14, an adjustment module 15, the virtual camera 16, and the 3D scenes 17. The modules 11-15 may include computerized code in the form of one or more programs that are stored in the storage device 40. The computerized code includes instructions to be processed by the processor 50 to provide the aforementioned functions of the 3D effect simulation unit 10. A detailed description of the functions of the modules 11-14 are illustrated in FIG. 3. The storage device 40 may be a cache or a dedicated memory, such as an EPROM, HDD, or flash memory.

FIG. 3 is a flowchart of one embodiment of a 3D effect simulation method. Depending on the embodiment, additional steps may be added, others removed, and the ordering of the steps may be changed.

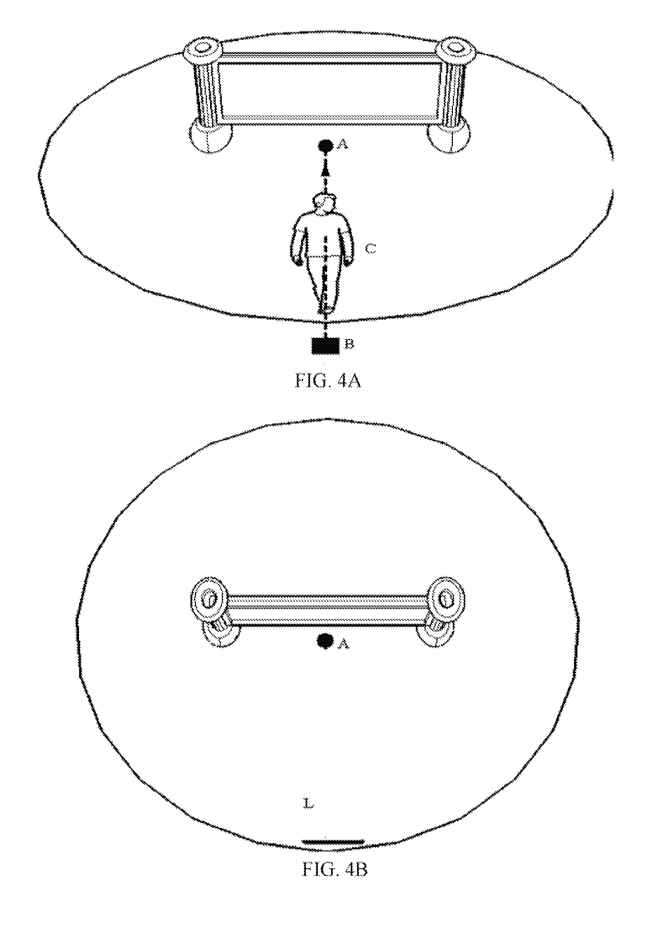

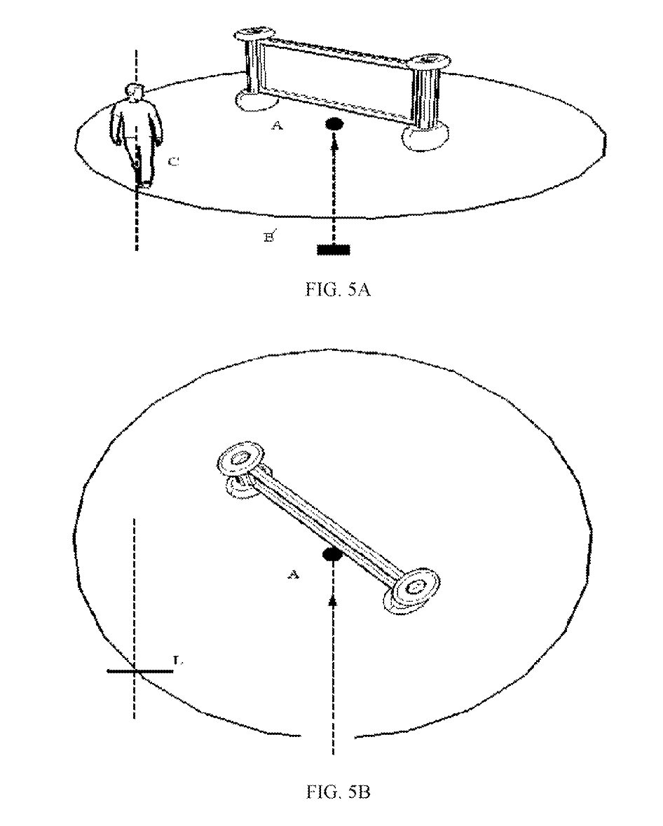

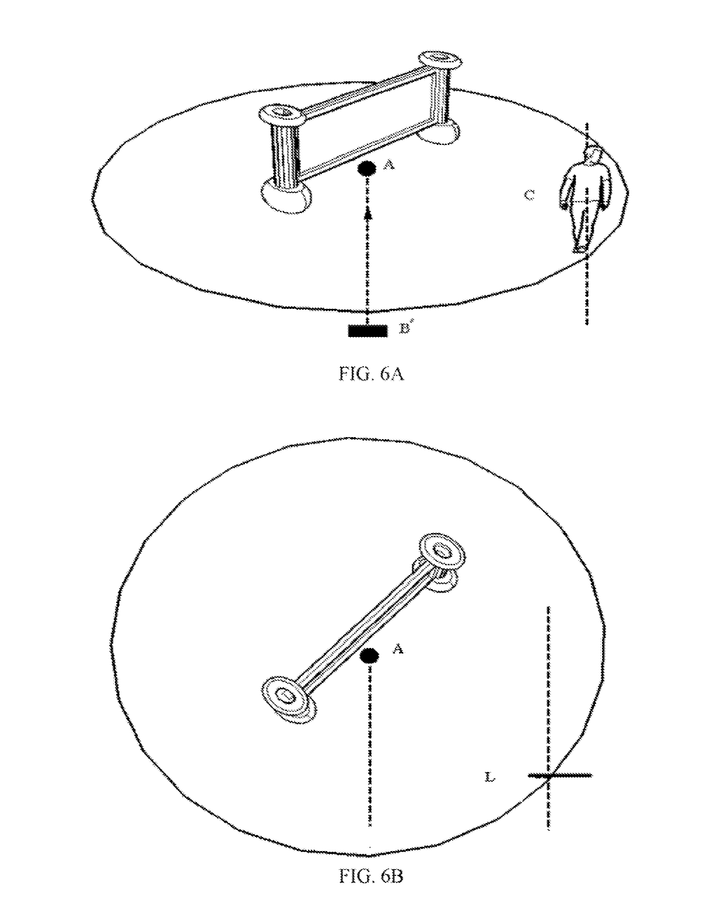

In step S31, the parameter setting module 11 sets an initial position of a virtual camera 16 that tracks 3D game scenes 17 of a 3D game displayed on the display screen 20 of the electronic device 100, and sets a viewpoint position of a user. In one embodiment, as mentioned above, when the user is playing the 3D game, eyes of the user act as the virtual camera 16 for tracking the 3D game scenes 17 in the 3D space. The viewpoint position of the user is a focus of sightlines of the user. As shown in FIG. 4A, an initial 3D scene 17 includes a ground represented by an ellipse, a billboard stood tall and upright on the ground, and a character C stood in front of the billboard. A shadow circle A represents the viewpoint position of the user in the 3D space, and a shadow rectangular B at the center of initial 3D scene 17 represents the initial position of the virtual camera 16 in the 3D space. In one embodiment, the viewpoint position is a fixed position in the 3D space, as shown in FIG. 4A-FIG. 6B, the viewpoint position A is the center of the 3D game scenes 17. The 3D game scenes 17 and main characters in the 3D game are created using 3D drawing software.

In step S32, the sightline direction determination module 12 determines an initial sightline direction of the user according to the initial position of the virtual camera 16 and the viewpoint position of the user. For example, as shown in FIG. 4A, a ray BA, which starts from the initial position B of the virtual camera 16 and passes the viewpoint position A of the user, represents the initial sightline direction of the user.

In step S33, the 2D object placement module 13 displays an object (such as a minor character C shown in FIG. 4A) represented by 2D graphics on the display screen 20 at a preset position in the 3D space. A plane of the 2D graphics is vertical to the initial sightline direction of the user, so that the user cannot recognize the character C is 2D from the initial sightline direction. In fact, viewing from the top of the 3D space, the character C is a line L as shown in FIG. 4B.

In step S34, the signal receiving module 14 receives an adjustment signal for adjusting a position of the virtual camera 16 input via the input device 30, and adjusts view of the virtual camera 16 by adjusting the virtual camera 16 from the initial position to a current position in the 3D space according to the adjustment signal. In one embodiment, change of the sightline direction of the user equals change of the position of the virtual camera 16 that tracks the 3D game scenes 17 in the 3D space. For example, the user may adjust the position of the virtual camera 16 rightwards (as shown in FIG. 5A) by pressing a right-arrow key on the keyboard, or adjust the position of the virtual camera 16 leftwards (as shown in FIG. 6A) by pressing a left-arrow key on the keyboard.

In step S35, the sightline direction determination module 12 determines a current sightline direction of the user according to the current position of the virtual camera 16 and the viewpoint position. For example, in response the position change of the virtual camera 16 rightwards, as shown in FIG. 5A, a ray B′A, which starts from a current position B′ of the virtual camera 16 and passes the viewpoint position A of the user, represents a current sightline direction of the user. In response to the position change of the virtual camera 16 leftwards, as shown in FIG. 6A, a ray B″A, which starts from a current position B″ of the virtual camera 16 and passes the viewpoint position A of the user, represents a current sightline direction of the user.

In step S36, the adjustment module 15 adjusts view of the plane of the 2D graphics representing the character C to be vertical to the current sightline direction of the user, so that the user cannot recognize the character C is 2D from the current sightline direction. For example, if the sightlines of the user moves rightwards, the adjustment module 15 may rotates the 2D graphics by certain degrees right or left according to a longitudinal axis of the 2D graphics, to adjust the character C from a state shown in FIG. 4A to a state shown in FIG. 5A to keep vertical with the current sightline direction B′A of the user. If the sightlines of the user moves leftwards, the adjustment module 15 may rotates the 2D graphics by a number of degrees right or left according to the longitudinal axis of the 2D graphics, to adjust the character C from the state shown in FIG. 4A to a state shown in FIG. 6A to keep vertical with the current sightline direction B″A of the user. As a result, the user cannot recognize the character C is represented by the 2D graphics from any sightline direction since the plane of the 2D graphic representing the character C always keeps vertical with the user's sightline directions. In fact, viewing from the top of the 3D space, the character C is a line L as shown in FIG. 5B and FIG. 6B.

The above embodiment takes one object represented by 2D graphics as an example to simulate 3D effect by adjusting orientation of the planes of the 2D graphic. More than one character in the 3D game can be represented by 2D graphics and to shown 3D effect based on aforementioned 3D effect simulation method.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A three-dimensional (3D ) effect simulation method being performed by execution of instructions by a processor of an electronic device, the method comprising:
setting an initial position of a virtual camera that tracks 3D game scenes of a 3D game in a 3D space displayed on a display screen of the electronic device, and setting a viewpoint position of a user in the 3D space;
determining an initial sightline direction of the user according to the initial position of the virtual camera and the viewpoint position of the user;
displaying an object represented by two-dimensional (2D ) graphics at a preset position in the 3D space on the display screen, wherein a plane of the 2D graphics is vertical to the initial sightline direction of the user such that the user cannot recognize the object is 2D from the initial sightline direction;
adjusting view of the virtual camera on the display screen by adjusting the virtual camera from the initial position to a current position in the 3D space according to a received adjustment signal input via an input device;
determining a current sightline direction of the user according to the current position of the virtual camera and the viewpoint position; and
adjusting view of the plane of the 2D graphics on the display screen representing the object to be vertical to the current sightline direction of the user such that the user cannot recognize the object is 2D from the current sightline direction.

2. The method of claim 1, wherein eyes of the user act as the virtual camera for tracking the 3D game scenes in the 3D space, and the viewpoint position of the user is a focus of sightlines of the user.

3. The method of claim 1, wherein adjustment of the plane of the 2D graphics representing the object to be vertical to the current sightline direction of the user is according to rotation of the 2D graphics by a preset degree right or left according to a longitudinal axis of the 2D graphics.

4. The method of claim 2, wherein the viewpoint position is a fixed position in the 3D space.

5. The method of claim 1, wherein the input device includes a keyboard and a mouse.

6. A non-transitory medium storing a set of instructions, the set of instructions capable of being executed by a processor of an electronic device to perform a three-dimensional (3D ) effect simulation, the method comprising:
setting an initial position of a virtual camera that tracks 3D game scenes of a 3D game in a 3D space displayed on a display screen of the electronic device, and setting a viewpoint position of a user;
determining an initial sightline direction of the user according to the initial position of the virtual camera and the viewpoint position of the user;
displaying an object represented by two-dimensional (2D ) graphics at a preset position in the 3D space on a display screen of the electronic device, wherein a plane of the 2D graphics is vertical to the initial sightline direction of the user such that the user cannot recognize the object is 2D from the initial sightline direction;
adjusting view of the virtual camera on the display screen by adjusting the virtual camera from the initial position to a current position according to a received adjustment signal input via an input device;
determining a current sightline direction of the user according to the current position of the virtual camera and the viewpoint position; and
adjusting view of the plane of the 2D graphics on the display screen representing the object to be vertical to the current sightline direction of the user such that the user cannot recognize the object is 2D from the current sightline direction.

7. The medium of claim 6 wherein eyes of the user act as the virtual camera for tracking the 3D game scenes in the 3D space, and the viewpoint position of the user is a focus of sightlines of the user.

8. The medium of claim 6, wherein adjustment of the 2D graphics representing the object to be vertical to the current sightline direction of the user is according to rotation of the 2D graphics by a preset degree right or left according to a longitudinal axis of the 2D graphics.

9. The medium of claim 7, wherein the viewpoint position is a fixed position in the 3D space.

10. The medium of claim 6, wherein the input device includes a keyboard and a mouse.

11. An electronic device, comprising:
a storage device;
a processor; and
one or more programs stored in the storage device and being executable by the processor, the one or more programs comprising:
a parameter setting module operable to set an initial position of a virtual camera that tracks 3D game scenes of a 3D game in a 3D space displayed on a display screen of the electronic device, and set a viewpoint position of a user;
a sightline direction determination module operable to determine an initial sightline direction of the user according to the initial position of the virtual camera and the viewpoint position of the user;
a two-dimensional (2D ) object placement module operable to display an object represented by two-dimensional (2D ) graphics at a preset position in the 3D space on a display screen of the electronic device, wherein a plane of the 2D graphics is vertical to the initial sightline direction of the user such that the user cannot recognize the object is 2D from the initial sightline direction;
a signal receiving module operable to adjust view of the virtual camera on the display screen by adjusting the virtual camera from the initial position to a current position according to a received adjustment signal input via an input device;
the sightline direction determination module further operable to determine a current sightline direction of the user according to the current position of the virtual camera and the viewpoint position; and
an adjustment module operable to adjust view of the plane of the 2D graphics on the display screen representing the object to be vertical to the current sightline direction of the user such that the user cannot recognize the object is 2D from the current sightline direction.

12. The device of claim 11, wherein eyes of the user act as the virtual camera for tracking the 3D game scenes in the 3D space, and the viewpoint position of the user is a focus of sightlines of the user.

13. The device of claim 11, wherein adjustment of the 2D graphics representing the object to be vertical to the current sightline direction of the user is according to rotation of the 2D graphics by a preset degree right or left according to a longitudinal axis of the 2D graphics.

14. The device of claim 12, wherein the viewpoint position is a fixed position in the 3D space.

15. The device of claim 11, wherein the input device includes a keyboard and a mouse.
